(19) United States
(12) Patent Application Publication
(10) Pub. No.: US 2006/0087508 A1
(43) Pub. Date: Apr. 27, 2006

(54) Method for the rapid image processing of two-dimensional images

(75) Inventors: Christopher Drexler, Lake in the Hills, IL (US); Joachim Homegger, Mohrendorf (DE); Martin Mack, Koblenz (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Aktiengesellschaft

(21) Appl. No.: 11/252,941

(22) Filed: Oct. 18, 2005

(30) Foreign Application Priority Data
Oct. 22, 2004 (DE) 10 2004 051 567.0

(51) Int. Cl. G06T 15/20; G06T 15/10; G06T 15/50; G06T 15/60

(52) U.S. Cl. 345/427; 345/426

(57) ABSTRACT

The invention relates to a method for the rapid image processing of two-dimensional images, in particular medical image recordings using image-modifying image processing algorithms, with which image processing is executed at least partially on a graphics card comprising at least one pixel shader unit and at least one vertex shader unit. With this method, the two-dimensional images are first transformed into three-dimensional representations, with which a first part of the image processing algorithms is executed on the vertex shader unit, and subsequently transformed back into two-dimensional representations, with which a second part of the image processing algorithms is executed on the pixel shader unit. The artificial generation of the three-dimensional representation from the two-dimensional images advantageously allows the vertex shader unit of the graphics card to be used for image processing, so that the computing capacity of the graphics card can be optimally utilized.

### CROSS REFERENCE TO RELATED APPLICATIONS

This application claims priority to the German application No. 10 2004 051 567.0, filed Oct. 22, 2004 which is incorporated by reference herein in its entirety.

### FIELD OF INVENTION

The present invention relates to a method for the rapid image processing of two-dimensional images, in particular medical image recordings, using image-modifying image processing algorithms, with which image processing is executed at least partially on a graphics card comprising at least one pixel shader unit and at least one vertex shader unit.

### BACKGROUND OF INVENTION

One main application area of the present invention is the rapid image processing of two-dimensional medical image recordings, which occur for instance in fluoroscopy. Medical-specific imaging methods such as computer tomography, x-ray angiography or magnetic resonance tomography for instance, require complex image processing of the images recorded using the corresponding modalities. This image processing is intended on the one hand to improve the image quality, for example by noise suppression, and on the other hand to highlight structures in the images essential for the respective diagnosis, for instance by means of edge sharpening or filtering.

### SUMMARY OF INVENTION

Rapid image processing is necessary particularly in the field of fluoroscopy, in which x-ray recordings of an examination area are recorded in rapid temporal sequence and g displayed immediately on a screen for the attending doctor. With modern fluoroscopy systems, the images are already processed at a speed of 30 frame/s with a resolution of 1024×1024 pixels and a bit depth of 16 bits. Image processing with the image-modifying and/or image-improving image processing algorithms takes place on an image computer connected to the recording modality. The image processing algorithms are combined in the so-called post-processing pipeline. The main problem of image processing is the high processing speed, as the doctor requires the images in real-time where possible for instrument navigation in the case of interventions, particularly with the use of a catheter.

With current master processors, the processing speed needed for this purpose cannot be achieved with the above image resolutions, so that until now specific hardware based on DSP (digital signal processing boards) boards has had to be developed and used for these applications. It is proposed in a parallel patent application by the same inventor to execute at least one part of the image processing algorithms on a modern graphics card. This proposal enables the use of standard hardware for such image processing, which incurs lower investment costs and can be updated in a flexible manner without major outlay.

Modern graphics cards nowadays feature at least one vertex shader unit and one pixel shader unit, with which three-dimensional objects, for instance for computer games or animations, can be converted at high speed into realistic two-dimensional representations for a screen. A graphics adapter of this type and its use are known from “Programmierbare Pixel-und Vertex-Shader am Beispiel des GeForce3 von NVIDIA”, (Programmable pixel and vertex shaders exemplified in the GeForce 3 by NVIDIA), Hauptseminar SS 2001, pages 1 to 26, eHB. US 2003/0020741 A1 discloses an improved use of systems with pixel shader units and graphic shader units by providing buffers, where already processed data can be used by different shader units and the programming of graphic applications can be improved. This also involves the two-dimensional display of three-dimensional objects.

An object of the present invention is thus to specify a method for the rapid image processing of two-dimensional images, in particular medical image recordings, said method requiring lower investment costs and exhibiting greater flexibility in terms of new hardware development than known systems and in particular making optimum use of the possibilities of the components used.

The object is achieved by the claims. Advantageous embodiments of the method are the subject matter of the dependent claims or can be inferred from the subsequent description as well as the exemplary embodiment.

With the present method for the rapid image processing of two dimensional images, in particular medical image recordings using image-modifying image processing algorithms, image processing is executed at least partially on a graphics card comprising at least one pixel shader unit and at least one vertex shader unit. Pixel shader units are programmable computing units within the rendering pipeline of a 3D graphics chip, which generate the illumination effects and surface effects in computer-generated views. Vertex shader units are programmable computing units in the graphics chip, with which three-dimensional transformations, in particular of triangular points of a computer graphic, can be implemented in an optimized manner.

With the present method, the two-dimensional input images are first transformed into three-dimensional representations, with which a first part of the image processing algorithms is executed on the vertex shader unit. The three dimensional representations processed in this manner are subsequently transformed back into two-dimensional representations, with which a second part of the image processing algorithms is executed on the pixel shader unit.

The proposed artificial generation of a three-dimensional representation from the two-dimensional images also advantageously allows the vertex shader unit to be used for the image processing of the two-dimensional images. The processing algorithms otherwise implemented using the two-dimensional images, for instance filtering, noise suppression or edge sharpening, are thus modified in a suitable manner so as to generate the same effects in the three-dimensional representations. The remaining image processing is then continued in the already partially processed images transformed back into a two-dimensional representation on the pixel shader unit, so that both units are used for image processing. This optimal use of the graphics card, in particular the vertex shader unit configured for three-dimensional transformations, allows more rapid image processing of two-dimensional images to be achieved, as is particularly required in the application mentioned at the start, namely fluoroscopy.

In the field of medical imaging, the images recorded by the corresponding imaging modalities are generally present as gray-scale value images. The transformation of these two-dimensional images into a three-dimensional representation preferably takes place by generating gray-scale value peaks from gray-scale values of pixels of the two-dimensional images. For this purpose, the gray-scale value images are first stored in a texture, which can be read by the shader units of the graphics card. This texture is projected onto a planar polygon grid, so that the corner points of the polygons each lie in a pixel center. The z-coordinates of the corner points of the polygons are weighted with the gray-scale value of the respective pixel in whose center they lie, so that the grid obtained in this way represents a gray-scale value peak of the image.

Modern graphics cards such as the Radeon 9700 series from ATI or subsequent models thereof feature processors with a programmable vertex and pixel shader unit. Vertex shader programs are executed in the vertex shader unit, said vertex shader program defining three-dimensional transformations, which transform each three-dimensional point (vertex). Pixel shader programs are executed in the pixel shader unit, in which an output color value is calculated per pixel of a texture. The polygon grid corresponding to the gray-scale value peaks can be represented as a collection of vertices, which can be processed on the programmable vertex shader unit. A graphics card with a programmable vertex and pixel shader unit allows the transfer of the calculation results from the vertex shader program to the subsequent pixel shader program. This possibility is utilized with the present method.

The present method divides the image processing algorithms into two parts. In the first part calculations are carried out on the corner points of the polygon grid represented by vertices after transformation into a three dimensional representation in the vertex shader unit. This polygon grid represents the gray-scale value peaks. In the second part output gray-scale values per pixel of the texture, which represents the current gray-scale value image, are calculated on the basis of the results from the calculations of the first part after transformation back into a two-dimensional representation, this calculation being effected in the pixel shader unit. The image processing algorithms can thus be divided such that a minimum processing time is represented on the graphics card. The hardware performance of a modern graphics card which is optimized for 3D image processing is thus optimally utilized for use in the image processing of two-dimensional images.

### BRIEF DESCRIPTION OF THE DRAWINGS

The present method is described in more detail below with reference to an exemplary embodiment in conjunction with the drawing, in which;

FIG. 1 shows an example of the data flow with the present method;

FIG. 2 shows an example to illustrate edge smoothing in an image by means of 2D image processing, and

FIG. 3 shows an example to illustrate edge smoothing in an image by means of 3D image processing according to the present method.

### DETAILED DESCRIPTION OF INVENTION

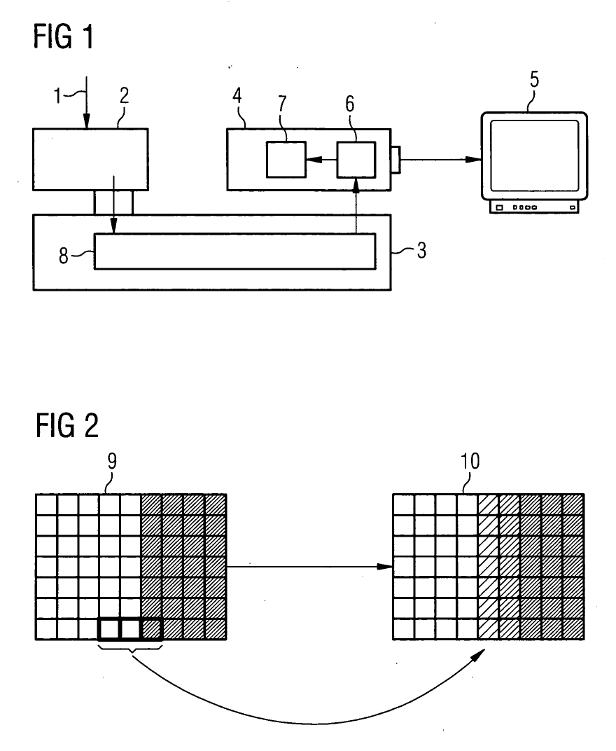

FIG. 1 shows an example of the data flow in the image computer during implementation of the present method based on x-ray image data. The raw data recorded using the x-ray device 1 is read in by an acquisition card 2 and transferred to the PC 3. A part of the required image processing is subsequently carried out on the master processor of the PC 3, as illustrated by the reference character 8. This image processing on the PC 3 is however not required in all instances, since all image processing can also take place on the graphics card 4, if it has adequate computing capacity.

With the present method, the image data is first transformed into a three-dimensional representation and subsequently transferred to the vertex shader unit 6 of the modern graphics card 4. One part of image processing takes place in this vertex shader unit 6, after which the image data processed in this manner is once again transformed back into a two-dimensional representation. The data transformed back is then transferred to the pixel shader unit 7 of the graphics card 4, in which the remaining image processing is carried out. The image processed in this way is finally displayed on a monitor 5 by means of the graphics card 4.

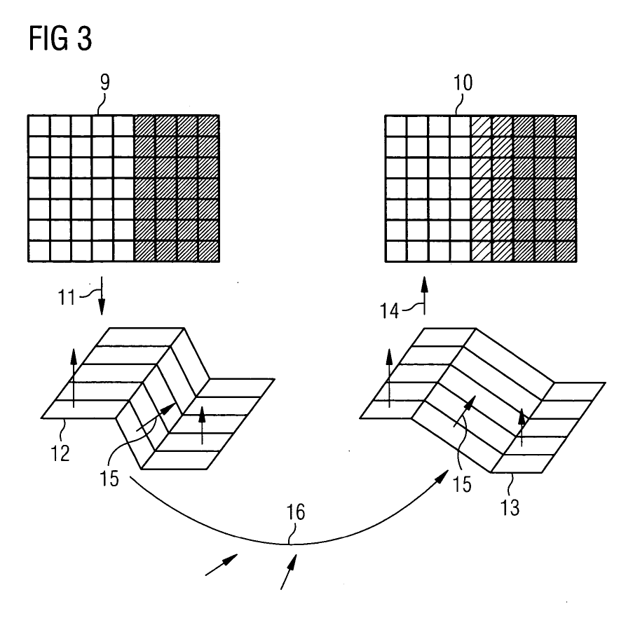

The three dimensional representation of the two dimensional image data artificially generated with the present method advantageously allows the use of a vertex shader unit of a modern graphics card for the image processing of the two-dimensional images. More rapid image processing is achieved by the improved use of the graphics card enabled in this way. The procedure selected in this manner is illustrated in exemplified form on the basis of the schematic illustrations in FIGS. 2 and 3. FIG. 2 thus shows two-dimensional image processing for edge smoothing in an image. The left part of the figure shows the input image 9 with the gray-scale value level, which is to be smoothed by image processing. Smoothing takes place in this case by means of two-dimensional averaging, for instance by forming a mean value for three adjacent points in each instance, as shown in FIG. 2. An output image 10 is achieved by means of this averaging, which features a flatter gray-scale value transition and thus a smoothed edge.

With the implementation of the present method, this two-dimensional image processing can now be executed by the vertex shader unit 6 of a modern graphics card 4 designed for three-dimensional image processing. The two-dimensional image 9 is converted for this purpose into a three-dimensional representation 12 by means of a transformation step 11, said three-dimensional representation 12 representing a gray-scale value peak of the two-dimensional image. The surface normals on this gray-scale value peak in FIG. 3 are shown as arrows. The angle of these surface normals to the horizontal is a measure of the intensity of a change in the gray-scale value. An angle of the surface normal 15 deviating significantly from 90° thus represents the change in the gray-scale value in the two-dimensional image 9. Edge smoothing can now take place in this three-dimensional representation by means of rotation 16 of the surface normals 15, as shown in the lower part of FIG. 3. Edge smoothing is achieved by increasing the angle of these surface normals 15 to the horizontal. Transforming the smoothed gray-scale value peak 13 obtained in this way back into a two dimensional representation 10 in a back transformation step 14 achieves the same result as the two-dimensional image processing in FIG. 2. The computing capacity of a modern graphics card comprising one or a number of vertex shader units for three-dimensional image processing can however be utilized significantly better in this manner. This technique can naturally also be transferred to other image processing techniques which were previously carried out in two dimensions.

1.-4. (canceled)

5. A method for the rapid image processing of two-dimensional images, comprising:
providing image-modifying image processing algorithms, at least part of the image processing algorithms implemented on a graphics card, the graphics card having at least one pixel shader unit and at least one vertex shader unit;
transforming the two-dimensional images into three-dimensional representations using a first part of the image processing algorithms, the first part of the image processing algorithms executed on the vertex shader unit; and
transforming the three-dimensional representations into two-dimensional representations using a second part of the image processing algorithms, the second part of the image processing algorithms executed on the pixel shader unit.

6. The method according to claim 5, wherein the two-dimensional images are medical image recordings.

7. The method according to claim 5, wherein transforming the two-dimensional images into the three-dimensional representations includes generating gray-scale value peaks from gray-scale values of pixels of the two-dimensional images.

8. The method according to claim 5, wherein the three-dimensional representations are polygon grids.

9. The method according to claim 5, wherein the first and second parts of the image processing algorithms are selected from the image processing algorithms and assigned to the pixel shader unit respectively vertex shader unit such that a processing time necessary for the transforming of the two-dimensional images and the three-dimensional representations using the graphics card is minimized.
